(19) United States
(12) Patent Application Publication
(10) Pub. No.: US 2013/0218587 A1
(43) Pub. Date: Aug. 22, 2013

(54) Coverage Discovery

(71) Applicant: PASSPORT HEALTH COMMUNICATIONS, INC., (US)

(72) Inventors: Max Edward Carter, JR., Greenbrier, TN (US); Brian Keith McNeece, Columbia, TN (US); Dustin Ryan Whittier, Nashville, TN (US)

(73) Assignee: PASSPORT HEALTH COMMUNICATIONS, INC., Franklin, TN (US)

(21) Appl. No.: 13/773,940

(22) Filed: Feb. 22, 2013

Related U.S. Application Data
(60) Provisional application No. 61/601,855, filed on Feb. 22, 2012.

(51) Int. Cl. G06F 17/30; G06Q 50/22

(52) U.S. Cl. CPC G06F 17/30424; G06Q 50/22
USPC 705/2

(57) ABSTRACT

Automated, intelligent coverage discovery is provided. A request to find hidden or additional coverage for a self-pay, government-funded payer, and commercial payer accounts may be received. Rules defining certain search criteria and actionable information, such as demographic and payer data manipulations to find coverage data, may be executed. Requests for eligibility verification may be sent to one or more payers. Responses may be received and analyzed to determine if a subsequent search for coverage data may need to be performed. Results data may be sent to the requesting party. Coverage data for accounts that may have been destined for write-offs or inappropriately classified as qualifying for charity or financial aid may be discovered. The accounts for which coverage data is found may then be submitted for payment by one or more payers.

### CROSS-REFERENCE TO RELATED APPLICATIONS

The present application claims priority to U.S. Provisional Patent Application No. 61/601,855 titled “Coverage Discovery” filed Feb. 22, 2012, the disclosure of which is incorporated herein by reference in its entirety.

### BACKGROUND

When a patient seeks healthcare services from a healthcare provider, various information, herein referred to as patient account information, may be requested from the patient such as demographic data and coverage data (i.e., insurance information). Patient account information may be used to file a claim for payment for healthcare services provided by the healthcare provider. Oftentimes, for a variety of reasons, patients may not provide coverage data, or may provide incorrect coverage data. Other times, demographic and/or coverage data may be incorrectly entered into a healthcare provider system. Accordingly, a healthcare provider may be less likely to collect payment for services provided to patients whose accounts have incorrect or missing demographic and/or coverage data. Such accounts may be unnecessarily destined for write-offs, or may be inappropriately qualified as charity.

Currently, manipulation of patient account information to try to find coverage data for a patient may be performed by healthcare provider staff. As can be appreciated, trying various data manipulations to try to find coverage data may be labor intensive, affecting staff productivity. If coverage data cannot be found via manual methods, a healthcare provider may utilize a third party collection agency to attempt to collect money from patients. As can be appreciated, it would be desirable to avoid third party collection agency expenses. It is with respect to these and other considerations that the present invention has been made.

### SUMMARY

Embodiments of the present invention provide coverage discovery. A request to find hidden or additional coverage for a self-pay, government-funded payer (e.g., Medicare, Medicaid, etc.), and commercial payer accounts may be received. One or more rules, which may be specific to a requesting party, may be executed. The rules may define certain search criteria, and may provide actionable information, such as demographic and payer data manipulations, to find coverage data. Requests for eligibility verification may be sent to one or more payers. Responses may be received and analyzed. If coverage data is not found, additional data manipulations may be executed, and a subsequent search for coverage data may be performed. Results data may be sent to the requesting party. By providing an automated, intelligent coverage discovery system, payment for accounts that may have otherwise been written off or incorrectly classified as qualifying for charity or financial aid, may be collected. Accordingly, a healthcare provider may find hidden or unknown revenue opportunities, reduce a total outstanding accounts receivables balance, decrease a number of accounts receivables days, improve cash flow, and see an increased gross margin and net profit.

### BRIEF DESCRIPTION OF DRAWINGS

FIG. 1 is a simplified block diagram of a high-level system architecture with which embodiments of the invention may be implemented.

FIG. 2 is a flow chart of a method of providing coverage discovery according to an embodiment.

FIG. 3 is a simplified block diagram of a computing device with which embodiments of the present invention may be practiced.

### DETAILED DESCRIPTION

As briefly described above, embodiments of the present invention provide automated, intelligent coverage discovery, which may be utilized to identify billable accounts that may be submitted for payment as primary, secondary, or tertiary coverage. Oftentimes, these accounts may be unnecessarily destined for write-off or may be inappropriately qualified for charity or financial assistance.

These embodiments may be combined, other embodiments may be utilized, and structural changes may be made without departing from the spirit or scope of the present invention. The following detailed description is therefore not to be taken in a limiting sense, and the scope of the present invention is defined by the appended claims and their equivalents. Referring now to the drawings, in which like numerals refer to like elements throughout the several figures, embodiments of the present invention and an exemplary operating environment will be described.

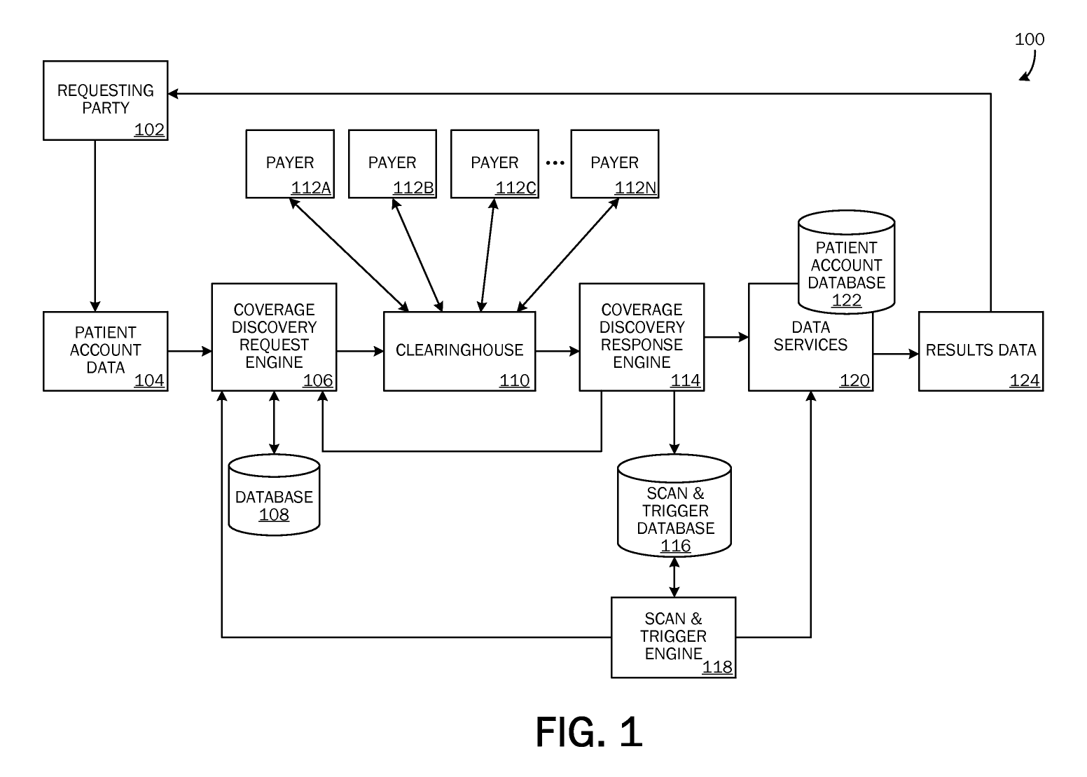

Referring now to FIG. 1, a simplified block diagram of a high-level system architecture 100 with which embodiments of the invention may be implemented is shown. The system 100 may comprise a coverage discovery request engine 106, referred to herein as a request engine 106. The request engine 106 may be operable to receive a request to try to find coverage data for a patient. A search for coverage data for a patient may be performed for various reasons. For example, a search may be performed to find coverage data for patients who have coverage, but who have claimed that they do not have any coverage. As another example, a search may be performed to find commercial coverage data for patients who have claimed to only have government-funded coverage. As another example, a search may be performed to find coverage data for patients who have provided erroneous coverage or demographics information or whose coverage or demographics information has been entered incorrectly into a healthcare provider information system.

According to embodiments, the request may be sent by a requesting party 102 to the request engine 106 via various methods. The requesting party 102 may be a healthcare provider, a payer, an intermediary party, etc. The request may be a file comprising patient account data 104, and may be sent to the request engine 106 via various data transaction methods as are known in the art. For example, patient account data 104 may be entered into a web page and sent to the request engine 106. As another example, patient account data 104 may be entered into a remote application, such as a coverage verification application. A set of application programming interfaces (APIs) may be exposed to remote applications and operating systems that allow the remote applications to communicate with the request engine 106 through common data calls understood via the API set. Data passed between the client side and server side may be formatted according to the Extensible Markup Language (XML).

The patient account data 104 may include demographics data and/or coverage data associated with the patient. For example, patient account data 104 may include a patient's name, address, phone number(s), social security number, date of birth, gender, marital status, emergency contact information, employment status and details, student status and details, insurance information, guarantor information, etc. If the requesting party 102 has performed a search for coverage data, the request sent to the request engine 106 may include results from the search.

When the request engine 106 receives a request, the request engine 106 may execute one or more rules to manipulate data to help find hidden coverage data or additional coverage for self-pay, government-funded, and commercial payer accounts. The rules may be stored in a database 108, and may be specific to a requesting party 102. One or more rules may be executed and may be executed in a specific order according to the requesting party 102. The rules may define data scrubbing processes and data manipulations to perform, such as various demographic heuristics. For example, phonetic algorithms may be applied to patients' names to search for coverage data by patient name despite variations in spelling, non-alphanumeric characters may be scrubbed from a patient's name, the middle name of a female patient may be swapped (e.g., maiden name), if a patient has a double last name, the order of the names may be swapped, date-of-birth information may be altered (+/−a day, swap day and month, etc.), a patient's state of residence may be used to search for coverage data, a search may be performed using fewer letters of a patient's name (e.g., search for “Josh” instead of “Joshua”), etc. Other data, such as processing data, configuration data, patient and patient account data 104, alerts from remote patient access workflow engines, and coverage and eligibility verification results data, may be stored in the database 108.

After one or more rules have been executed, the request engine 106 may submit a request to a clearinghouse 110 to send one or more eligibility verification request transactions to various payers 112 as determined by the request engine 106. According to embodiments, a request for data may be sent to other data sources, for example, demographic verification sources (e.g., utility billing databases, phone company listings, credit bureaus, the United States Social Security Administration's death master file, the United States Postal Service® change of address records, state drivers license databases, magazine subscription records, moving company records, mobile phone application information, rental agreements, rental applications, etc.). Web scraping for patient and coverage information and patient employer lookup may also be performed.

Responses to the requests may be received by the clearinghouse 110 and provided to a response engine 114. According to embodiments, the response engine 114 may be operable to analyze a response and determine if an additional search should be performed. The response engine 114 may also be operable to detect and correct discrepancies on a patient account that may cause an inaccurate financial classification. Crucial data discrepancies, such as an incorrect member identification number, subscriber or dependent name spelling, social security number, etc., may be identified and flagged. According to an embodiment, the response engine 114 may be operable to tag a patient account for future review. Various rules may be applied to determine which accounts to tag for future review. For example, a patient with no medical insurance coverage may be admitted to a hospital. Through a process of financial counseling, the patient may be assisted in enrolling for government-subsidized insurance (e.g., Medicaid). If the patient is discharged from the hospital before the government-subsidized insurance application is processed and approved, the patient's account may be tagged for future review (i.e., coverage discovery). An account that has been tagged for future review may be stored in a scan and trigger database 116.

The system 100 may include a data services server 120 operable as a central repository of data. For example, placement and payment files, claims data, interface data, product data, etc. may be stored in the data services server 120. The data services server 120 may also comprise a patient accounts database 122 for storing patient account data 104, included any coverage data discovered by the system 100. According to embodiments, patient account data 104 associated with an account for which coverage data is not discovered may be stored in the patient accounts database 122, and may be tagged and automatically resubmitted through the coverage discovery process after a predetermined amount of time for a subsequent coverage data search. For example, certain payers, such as Medicaid, may provide coverage for healthcare services provided within three months prior to enrollment with the payer. Prior to a patient enrolling, a coverage search may be performed and not find coverage data for the patient; however, a subsequent search may be performed, discovering coverage data for the payer with which the patient enrolled.

The system 100 may also include a scan and trigger engine 118 operable to perform a scan for patient accounts that may be tagged for future review and to scan other databases, for example, the patient accounts database 122, to identify patient accounts that may meet one or more criteria for reprocessing through the coverage discovery process. Tagged and selected accounts may be sent back to the coverage discovery request engine 106.

When coverage data is discovered, results data 124 may be sent to the requesting party 102. Results data 124 may be provided in various formats, for example, in a report, via a website, or may be injected into a file, sent to a requesting party application, and displayed on a user interface. The requesting party application may be communicable with the system 100 via APIs.

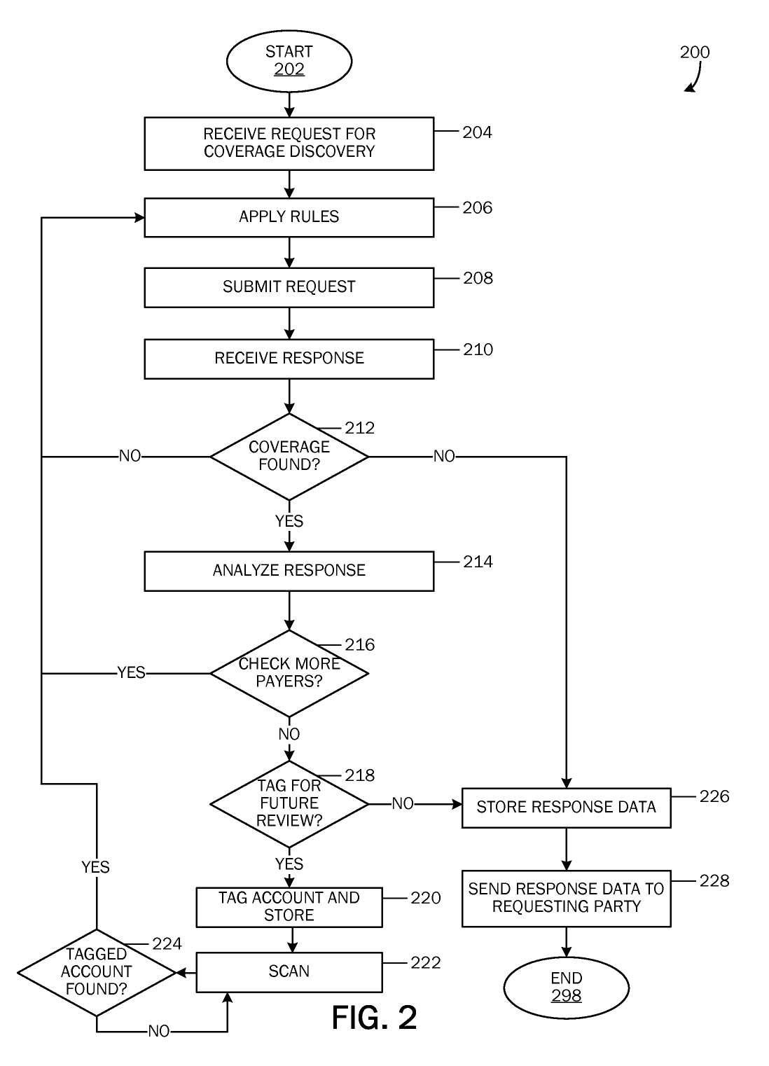

Having described a high-level system architecture 100 with which embodiments of the invention may be implemented, FIG. 2 illustrates a flow chart of a method 200 of providing coverage discovery according to an embodiment. The method 200 starts at OPERATION 202 and proceeds to OPERATION 204, where a request for performing coverage discovery is received. As described above, the request may include patient account data 104, and may include a scrap file from a previous demographics and/or coverage verification process.

When a request is received, the method 200 may proceed to OPERATION 206, where one or more rules may be executed. Execution of the one or more rules may determine which payers to select for a search, and may manipulate demographic and or payer data for submitting in an eligibility verification request. At OPERATION 208, one or more requests for coverage or eligibility verification may be submitted to one or more payers 112. According to embodiments, the eligibility verification request may include modified demographic and/or payer data, the modified demographic and/or payer data manipulated according to the one or more rules.

At OPERATION 210, a response to one of the one or more requests for coverage or eligibility verification may be received. At DECISION OPERATION 212, the response may be analyzed to determine if coverage data has been found. If a determination is made that coverage data is not found, the process may return to OPERATION 206, where one or more additional rules may be applied and a subsequent eligibility verification request may be sent to one or more payers 112. If, after all rules have been applied and no coverage data is discovered, the patient account data 104 and any results data may be stored at OPERATION 220.

If, at DECISION OPERATION 212, a determination is made that coverage data is found, the method 200 may proceed to OPERATION 214, where the response may be analyzed. For example, the response may be analyzed to determine if the coverage or eligibility data in the response may be applicable to the request (i.e., a false positive). For example, a response may indicate that a patient has coverage; however, the coverage may be vision coverage, which may not be applicable for a request for eligibility verification for a non-vision healthcare encounter. At DECISION OPERATION 216, a determination may be made to determine if additional payers 112 may need to be checked for coverage data or eligibility verification. If yes, the method 200 may return to OPERATION 206, where one or more additional rules may be applied and a subsequent eligibility verification request may be sent to one or more payers 112.

If, at DECISION OPERATION 216, a determination is made that an additional eligibility verification request does not need to be sent to additional payers 112, the method 200 may proceed to DECISION OPERATION 218, where a determination may be made if an account should be tagged for future review. If an account is determined to be tagged for future review, at OPERATION 220, the account may be tagged and stored in a database, such as the scan and trigger database 116.

The method 200 may proceed to OPERATION 222, where one or more databases 116,122 may be scanned for tagged and stored patient account data 104 to resend through the process for coverage discovery. At DECISION OPERATION 224, a determination may be made to determine if a patient account is tagged or meets criteria to be processed through the system 100 in an attempt to discover coverage data. If an account is tagged or determined to meet the criteria, the account may be resubmitted to the request engine 106, and the method 200 may return to OPERATION 206, where one or more additional rules may be applied and a subsequent eligibility verification request may be sent to one or more payers 112. If, at DECISION OPERATION 224, a tagged account or an account meeting criteria to be reprocessed through the coverage discovery process in an attempt to discover coverage data is not found, the method 200 may return to OPERATION 222.

If at DECISION OPERATION 218, a determination is made to not tag an account for future review, the method 200 may proceed to OPERATION 226, where the response data may be stored. As described above, the response data, as well as patient account data 104 and results of where coverage data for an account is not found, may be stored in a central data repository (i.e., data services 120).

At OPERATION 228, results data 124 may be sent to the requesting party 102. As described above, results data 124 may be provided in various formats, for example, in a report, via a website, or may be injected into a file, sent to a requesting party application, and displayed on a user interface. The results data may 124 identify billable accounts that may be submitted for payment as primary, secondary, or tertiary coverage. The method 200 may end at OPERATION 298.

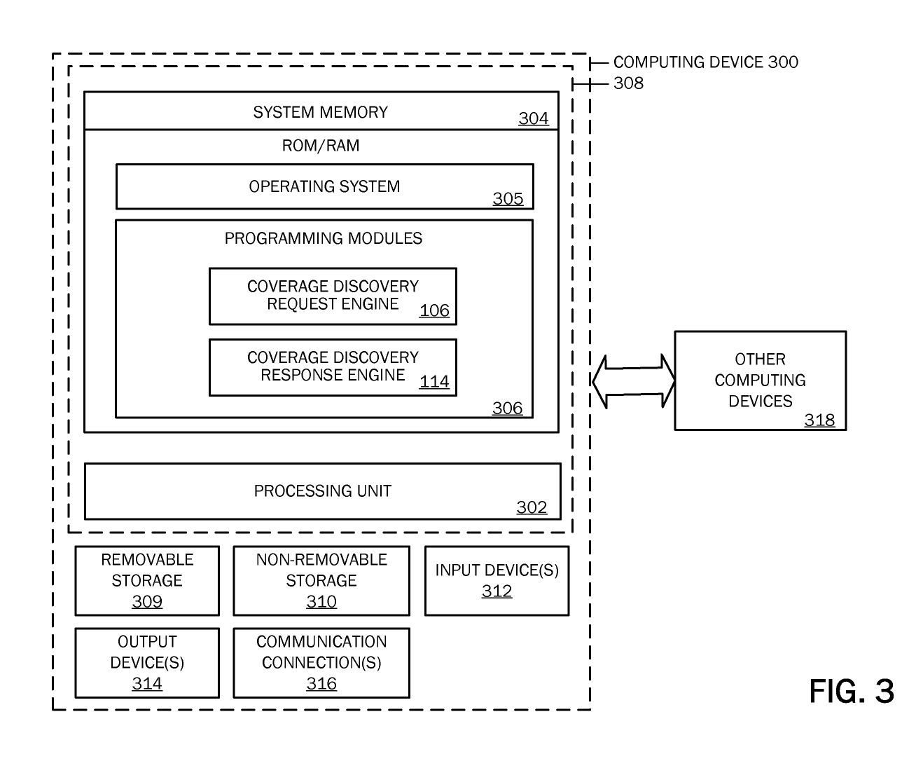

Embodiments of the invention may be implemented via local and remote computing and data storage systems. Such memory storage and processing units may be implemented in a computing device, such as computing device 300 of FIG. 3. Any suitable combination of hardware, software, or firmware may be used to implement the memory storage and processing unit. For example, the memory storage and processing unit may be implemented with computing device 300 or any other computing devices 318, in combination with computing device 300, wherein functionality may be brought together over a network in a distributed computing environment, for example, an intranet or the Internet, to perform the functions as described herein. Such systems, devices, and processors (as described herein) are examples and other systems, devices, and processors may comprise the aforementioned memory storage and processing unit, consistent with embodiments of the invention.

With reference to FIG. 3, a system consistent with embodiments of the invention may include one or more computing devices, such as computing device 300. The computing device 300 may include at least one processing unit 302 and a system memory 304. The system memory 304 may comprise, but is not limited to, volatile (e.g. random access memory (RAM)), non-volatile (e.g. read-only memory (ROM)), flash memory, or any combination. System memory 304 may include operating system 305, one or more programming modules 306, and may include a request engine 106 and a response engine 114, wherein the request engine 106 and the response engine 114 are software applications having sufficient computer-executable instructions, which when executed, perform functionalities as described herein. Operating system 305, for example, may be suitable for controlling computing device 300's operation. Furthermore, embodiments of the invention may be practiced in conjunction with a graphics library, other operating systems, or any other application program and is not limited to any particular application or system. This basic configuration is illustrated in FIG. 3 by those components within a dashed line 308. Computing device 300 may also include one or more input device(s) 312 (keyboard, mouse, pen, touch input device, etc.) and one or more output device(s) 314 (e.g., display, speakers, a printer, etc.).

Although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

The computing device 300 may also include additional data storage devices (removable and/or non-removable) such as, for example, magnetic disks, optical disks, or tape. Such additional storage is illustrated in FIG. 3 by a removable storage 309 and a non-removable storage 310. Computing device 300 may also contain a communication connection 316 that may allow device 300 to communicate with other computing devices 318, such as over a network in a distributed computing environment, for example, an intranet or the Internet. Communication connection 316 is one example of communication media.

Program modules, such as the request engine 106 and the response engine 114, may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable user electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

Embodiments of the present invention, for example, are described above with reference to block diagrams and/or operational illustrations of methods, systems, and computer program products according to embodiments of the invention. For example, FIGS. 1-3 and the described functions taking place with respect to each illustration may be considered steps in a process routine performed by one or more local or distributed computing systems. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

It will be apparent to those skilled in the art that various modifications or variations may be made in the present invention without departing from the scope or spirit of the invention. Other embodiments of the invention will be apparent to those skilled in the art from consideration of the specification and practice of the invention disclosed herein.

All rights including copyrights in the code included herein are vested in and the property of the Applicant. The Applicant retains and reserves all rights in the code included herein, and grants permission to reproduce the material only in connection with reproduction of the granted patent and for no other purpose.

We claim:

1. A method for providing coverage discovery, the method comprising:
receiving a request to find coverage data, the request comprising patient account data;
applying one or more rules to the patient account data;
sending one or more requests for eligibility verification to one or more payers;
receiving a response to a request for eligibility verification;
analyzing the response;
determining if coverage data is found;
if coverage data is not found, applying one or more additional rules to the patient account data and sending one or more requests for eligibility verification to one or more payers; and
if coverage data is found, storing the coverage data.

2. The method of claim 1, wherein receiving a request to find coverage data comprises receiving patient account data via a web page or via a remote application.

3. The method of claim 1, wherein applying one or more rules to the patient account data comprises applying one or more demographic data heuristics.

4. The method of claim 3, wherein applying one or more demographic data heuristics comprises one or more of:
applying a phonetic algorithm to a patient's name;
scrubbing non-alphanumeric characters from a patient's name;
swapping a middle and last name of a female patient;
altering date-of-birth information;
using fewer letters of a patient's name; or
using a patient's state of residence to determine where to perform a search.

5. The method of claim 1, further comprising requesting data from other data sources, the other data sources comprising one or more demographic verification sources.

6. The method of claim 1, wherein analyzing the response comprises identifying and correcting data discrepancies.

7. The method of claim 1, further comprising:
scanning stored patient account data;
selecting one or more patient accounts for which to perform a search for coverage data;
applying one or more rules to the patient account data; and
sending one or more requests for eligibility verification to one or more payers.

8. The method of claim 1, further comprising:
if coverage data is not found, tagging a patient account associated with the patient account data for a future coverage data search;
storing the patient account data in a database;
searching the database for one or more tagged patient accounts; and
if a tagged patient account is found, applying one or more rules to the patient account data associated with the tagged patient account; and
sending one or more requests for eligibility verification to one or more payers.

9. The method of claim 1, further comprising sending the found coverage data to a requesting party.

10. A system for providing coverage discovery, the system comprising:
a memory storage; and
a processing unit coupled to the memory storage, wherein the processing unit is operable to:
receive a request to find coverage data, the request comprising patient account data;
apply one or more rules to the patient account data;
send one or more requests for eligibility verification to one or more payers;
receive a response to a request for eligibility verification;
analyze the response;
determine if coverage data is found;
if coverage data is not found, apply one or more additional rules to the patient account data and sending one or more requests for eligibility verification to one or more payers;
if coverage data is found, store the coverage data; and
send the coverage data to a requesting party.

11. The system of claim 10, wherein the one or more rules comprise one or more demographic data heuristics.

12. The system of claim 11, wherein the one or more demographic data heuristics comprises one or more of:
application of a phonetic algorithm to a patient's name;
scrubbing of non-alphanumeric characters from a patient's name;
swapping of a middle and a last name of a female patient;
altering of date-of-birth information;
use of fewer letters of a patient's name; or
use of a patient's state of residence to determine where to perform a search.

13. The system of claim 10, wherein the processor is further operable to request data from other data sources, the other data sources comprising one or more demographic verification sources.

14. The system of claim 10, wherein the processor is further operable to identify and correct data discrepancies.

15. The system of claim 10, wherein the processor is further operable to:
scan stored patient account data;
select one or more patient accounts for which to perform a search for coverage data;
apply one or more rules to the patient account data; and
send one or more requests for eligibility verification to one or more payers.

16. The system of claim 10, wherein if coverage data is not found, the processor is further operable to:
store the patient account data in a database; and
perform a subsequent coverage data search after a predetermined amount of time.

17. A computer readable medium containing computer executable instructions which when executed by a computer perform a method of providing coverage discovery, comprising:
receiving a request to find coverage data, the request comprising patient account data;
applying one or more rules to the patient account data;
sending one or more requests for eligibility verification to one or more payers;
receiving a response to a request for eligibility verification;
analyzing the response;
determining if coverage data is found;
if coverage data is not found, applying one or more additional rules to the patient account data and sending one or more requests for eligibility verification to one or more payers;
if coverage data is found, storing the coverage data; and
sending the coverage data to a requesting party.

18. The computer readable medium of claim 17, wherein applying one or more rules to the patient account data comprises applying one or more demographic data heuristics, the one or more demographic data heuristics comprising one or more of:
applying a phonetic algorithm to a patient's name;
scrubbing non-alphanumeric characters from a patient's name;
swapping a middle and last name of a female patient;
altering date-of-birth information;
using fewer letters of a patient's name; or
using a patient's state of residence to determine where to perform a search. The method of claim 1, further comprising requesting data from other data sources, the other data sources comprising one or more demographic verification sources.

19. The computer readable medium of claim 17, wherein analyzing the response comprises identifying and correcting data discrepancies.

20. The computer readable medium of claim 17, further comprising:
scanning stored patient account data;
selecting one or more patient accounts for which to perform a search for coverage data;
applying one or more rules to the patient account data; and
sending one or more requests for eligibility verification to one or more payers.
